(19) United States
(12) Patent Application Publication
(10) Pub. No.: US 2017/0310698 A1
(43) Pub. Date: Oct. 26, 2017

(54) Validating Strength Values For Account Security Questions

(71) Applicant: Avaya Inc., Santa Clara, CA (US)

(72) Inventors: Reinhard KLEMM, Basking Ridge, NJ (US); Parameshwaran KRISHNAN, BASKING RIDGE, NJ (US); Navjot SINGH, SOMERSET, NJ (US)

(21) Appl. No.: 15/133,655

(22) Filed: Apr. 20, 2016

(51) Int. Cl. H04L 29/06

(52) U.S. Cl. CPC H04L 63/1433; H04L 63/1441

(57) ABSTRACT

A device, system, and method validates strength values for security questions associated with an online account. The method performed by an online service server includes receiving a security question data from a user device, the security question data being utilized for a user authentication to access an account of a user. The method includes performing a search, using third party sources, to generate search result data, the search result data being indicative of an availability value of responses to the security question data. The method includes determining a strength value of the security question data based on the search result data.

### BACKGROUND

The Internet or other network configurations enable organizations to provide online services to users. The users may create an online account with the organization to utilize the online services. In creating the online account, the user may provide general information (e.g., name, associated email, age, etc.). The user may also select a login and password to access the online account. Although the password provides a first authentication operation for the user to verify that the user is indeed the correct user, unauthorized third parties may attempt to access the online account through various methods in which the user's login and password are provided.

To provide further security measures to the user-selected password, the organization may require security access information to be provided such as security questions as part of the account setup operation. For example, the organization may be associated with private information (e.g., bank account information) that the user wishes to ensure is inaccessible to unauthorized users. Thus, the additional level of security may be provided for this purpose. When the security access information is security questions, the user may select a security question from a list of available security questions and provides the answer to the selected security question. An online server for the organization may then store the question/answer combination for use in subsequent user authentication or information retrieval purposes. The online server may request that the user select a second, a third, etc. security question and provide corresponding answers thereto. For example, when the user attempts to log into the online account at a later time or to recover the account login or password, the online server may request that the user provide the correct answer to one of the stored security questions having an associated answer. When the correct answer is provided by the user, the requested information may be provided for the online account.

However, as the security questions are pre-generated, the security questions often relate to information associated with the user such as historical information (e.g., mother's maiden name, high school graduation year, etc.) or personal preference/taste information (e.g., favorite teacher, favorite movie/music, etc.). With the Internet becoming more and more prolific with a wide dissemination of information and an increasing use of personal outlets such as social media, the information associated with the user also becomes more available to third parties. Therefore, a third party may be capable of determining the answers to the security questions based upon available information (often publicly available information) online.

### BRIEF SUMMARY

The exemplary embodiments are directed to a method comprising: receiving, by an online service server, a security question data from a user device, the security question data being utilized for a user authentication to access an account of a user; performing, by the online service server, a search, using third party sources, to generate search result data, the search result data being indicative of an availability value of responses to the security question data; and determining, by the online service server, a strength value of the security question data based on the search result data.

The exemplary embodiments are directed to an online service server comprising: a transceiver communicating with a communications network to communicate with a user device utilized by a user, the transceiver receiving a security question data from the user device, the security question data being utilized for a user authentication to access an account of a user; a processor coupled to the transceiver; and a memory arrangement with an executable program stored thereon, the program instructing the processor to perform operations comprising: performing a search, using third party sources, to generate search result data, the search result data being indicative of an availability value of responses to the security question data; and determining a strength value of the security question data based on the search result data.

The exemplary embodiments are directed to a method comprising: receiving, by an online service server, an access request to access an account of a user from a user device, the account associated with a user account profile data including a security question data, an answer data corresponding to the security question data, and a strength value corresponding to the security question data, the strength value based on search result data of a search using third party sources, the strength value being indicative of an availability value of responses to the security question data; determining, by the online service server, a timer value based on the strength value; transmitting, by the online service server, an answer request to the user device requesting the answer data to be provided for the security question data; and granting, by the online service server, access to the account by the user device when the answer data is received within the timer value.

### BRIEF DESCRIPTION OF THE DRAWINGS

FIG. 1 shows an exemplary system according to the present disclosure.

FIG. 2 shows an exemplary online service server of the system of FIG. 1 according to the present disclosure.

FIG. 3 shows an exemplary method for validating a strength value of security access data during a creation of an online account according to the present disclosure.

FIG. 4 shows an exemplary method for validating a strength value of security access data after an online account has been created according to the present disclosure.

FIG. 5 shows an exemplary method for responding to an account access request according to the present disclosure.

### DETAILED DESCRIPTION

The exemplary embodiments may be further understood with reference to the following description and the related appended drawings, wherein like elements are provided with the same reference numerals. The exemplary embodiments are related to a device, a system, and a method for validating a strength value associated with security access data associated with a user account. Specifically, the security access data may be a security question/answer combination provided by the user of the user account. The exemplary embodiments provide a mechanism in which a search is performed for the security access data to determine the likelihood that an unauthorized third party is capable of determining the security question/answer combination.

The exemplary embodiments provide a mechanism performing a validating operation to security access data associated with an online account of a user. The validating operation may indicate a relative strength of the security access data regarding whether the security access data may be easily determined by a third party. When the security access information is a security question/answer combination, an important feature for the user is that the combination is easy for the user to remember while being difficult or impossible for an unauthorized third party to determine the combination. When the security question of a user is presented to an unauthorized third party, the third party may ascertain the answer to the security question through various online searches, particularly through social media. For example, if the question asks the name of the favorite pet of the user and the user frequently posts pictures of the favorite pet on a social media outlet with accompanying text including the pet's name, the third party monitoring the user's social media page will be able to answer this security question. Therefore, the exemplary embodiments gauge the relative strength of the security question/answer combination and provide a corresponding display of the strength such that the user may determine whether to utilize this security question/answer combination in the security access data.

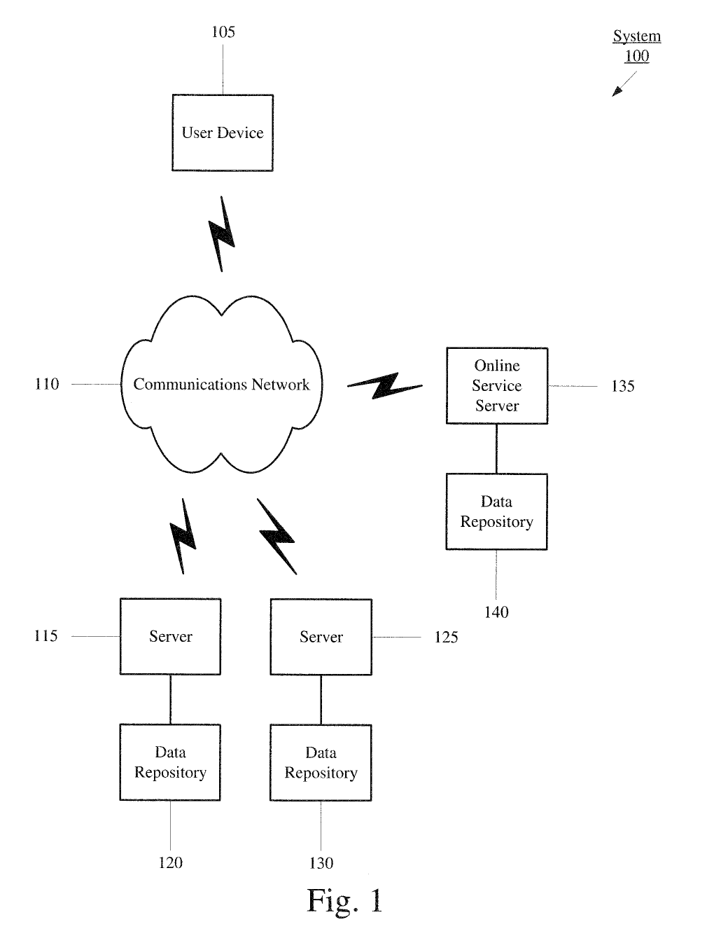

FIG. 1 shows an exemplary system 100 according to the exemplary embodiments of the present disclosure. The system 100 may represent a plurality of components that interact with one another for data to be exchanged in an online manner. Specifically, the system 100 may relate to a user device 105 utilized by a user who maintains an account with a plurality of websites over the Internet. The websites may be operated by the servers 115, 125. The system 100 may also relate to the user who wishes to create and maintain an online account with an online service that is operated by an online service server 135. The exemplary embodiments are directed to an operation performed by the online service server 135 with regard to security access data associated with the online account.

The user device 105 may enable the user to utilize a variety of online products and services. The user device 105 may establish a connection to a communications network 110 using a wireless connection and/or a wired connection to go online.

Accordingly, the user device 105 may perform a variety of operations associated with the online services and products such as embodied in websites provided by the servers 115, 125 and the online service server 135. Specifically, the user device 105 may request information from the servers 115, 125, receive the requested information, provide further inputs in utilizing the services/products, etc. associated with the websites provided by the servers 115, 125.

The user device 105 may represent any electronic device that is configured to perform the functionalities described herein. For example, the user device 105 may be a portable device such as a tablet, a smartphone, a laptop, a wearable, etc. In another example, the user device 105 may be a client stationary device such as a desktop terminal. The user device 105 may include the necessary software, hardware, and/or firmware required to utilize the online products and services. For example, the user device 105 may include a processor and memory to execute various applications including a web browser application when connected to the Internet, may include a transceiver to establish the connection to the Internet, may include an input/output device to provide commands, information, inputs, etc. while utilizing the online products/services, etc.

The communications network 110 may represent any single or plurality of networks used by the user device 105 and the servers 115, 125, 135 to communicate with one another. Specifically, the communications network 110 may include the Internet. For example, if the user device 105 is a personal home computer, the communications network 110 may include a home network in which the user device 105 may initially connect. The home network may connect to a network of an Internet service provider to connect to the Internet. Through the Internet, the user device 105 may communicate with the servers 115, 125, 135. It should be noted that the communications network 110 and all networks that may be included therein may be any type of network. For example, the communications network 110 may be a local area network (LAN), a wide area network (WAN), a virtual LAN (ULAN), a WiFi network, a HotSpot, a cellular network (e.g., 3G, 4G, Long Term Evolution (LTE), etc.), a cloud network, a wired form of these networks, a wireless form of these networks, a combined wired/wireless form of these networks, etc. The communications network 110 may also represent one or more networks that are configured to connect to one another to enable the data to be exchanged among the components of the system 100.

The exemplary embodiments are described with regard to the communications network 110 including the Internet and websites hosted on the Internet by the servers 115, 125, 135. However, it should be noted that the use of the Internet is only exemplary and is intended to represent any network communication configuration for the user device 105 to utilize network products and services provided by the servers 115, 125, 135 through the network communication configuration. Furthermore, the servers 115, 125, 135 may not host the website directly. For example, the servers 115, 125, 135 may utilize a website hosting service provided by another network entity. However, for exemplary purposes, the description herein relates to the servers 115, 125, 135 hosting the respective website.

The servers 115, 125 may represent any web server that hosts a website on the Internet. Accordingly, the servers 115, 125 may include a plurality of components such as a processor, a memory, a transceiver, etc. The website may provide any online service and/or product for users on the Internet. Relative to the online service server 135, the servers 115, 125 may represent third party sources of information. The website may represent any set of related web pages that is hosted by the servers 115, 125 and accessible via the communications network 110 (e.g., the Internet) using identifiers such as an Internet address (e.g., a uniform resource locator (URL)). The website hosted by the servers 115, 125 may require a subscription or an online account to access selected or all of the content, the services, and/or the products. For example, a file-sharing website may require a user to log into an online account of the website to access all of the content associated with the user. In another example, a news website may allow a general web page with news items to be viewed or only partial news items without a user logging into an online account but may require a user to log into the online account of the website to access the full news item or further news items on further web pages (e.g., as may be defined by the subscription that is enrolled by the user for the website). In a further example, a social media website may allow publicly available information or posts (as may be set by the owner of the information/post) to be viewed without any user online account with the social media website but may allow further information or posts to be viewed when logging into an online account for the user, particularly information/posts of other users who are part of a social network of the user. It is noted that the social network may also enable still further information/posts to be viewed such as those of a first user who is directly in the social network of the user and a second user who is indirectly in the social network of the user via being directly in the social network of the first user. This may further extend to a third user, a fourth user, etc. who is directly in the social network of the second user, the third user, etc., respectively.

The servers 115, 125 may also utilize data repositories 120, 130, respectively. The data repositories 120, 130 may be storage components for data associated with the servers 115, 125 and the websites being hosted thereby. Specifically, the data repositories 120, 130 may store data related to the online accounts of the user utilizing the user device 105. For exemplary purposes, the user utilizing the user device 105 may be assumed to have online accounts with the website hosted by the server 115 as well as the website hosted by the server 125. When the servers 115, 125 host social media websites, the data repositories 120, 130 may also store connections between online accounts of users such as may be represented with a topographic representation of the social network.

It should be noted that the use of the servers 115, 125 is only exemplary. Specifically, the number of servers 115, 125 being two is only exemplary. Those skilled in the art will understand that there may be any number of servers that may be associated with the Internet and the communications network 110.

These servers may each host a respective website on the Internet which may be used by the user utilizing the user device 105. The user utilizing the user device 105 may also have online accounts with only select ones of the websites. For example, the user may have a first online account with the website hosted by the server 115, a second online account with a website hosted by a further server, etc. but may not have an online account with a website hosted by the server 125, a website hosted by a further server, etc.

The online service server 135 may be substantially similar to the servers 115, 125. Specifically, the online service server 135 may host a website that provides a service to the user on the Internet. Although the online service server 135 is described herein as providing an online service, it should be noted that the online service server 135 may also provide an online product and online content. The online service server 135 may also utilize a data repository 140. The data repository 140 may be a storage component for data associated with the server 140 and the websites being hosted thereby as well as the online account information of the user utilizing the user device 105. As will be described in further detail below, the repository 140 may also store security access data that is used as a security measure when accessing the online account.

Although the online service server 135 may be substantially similar to the servers 115, 125, the online service server 135 according to the exemplary embodiments may represent an online hosting of a website that the user, utilizing the user device 105, wishes to create an online account and maintain the online account (e.g., subsequent login operations to be performed after online account setup). As will be described in further detail below, the exemplary embodiments may be directed to a first mechanism associated with creating the online account with the website hosted by the online service server 135 in which security access data is used, a second mechanism associated with validating the security access data, and a third mechanism associated with utilizing the security access data for access attempts to the created online account.

It should be noted that the online service server 135 according to the exemplary embodiments being used over a network is only exemplary. The functionalities and mechanisms described herein with regard to the security access data may relate to any account or information (online or offline) that is to be accessed by a user. That is, the account access may also be for non-Internet related uses. For example, a contact center may maintain or have access to accounts for users associated with an organization. The contact center may utilize real-time or non-real-time communication channels. For example, the real-time communication channels may include voice communications, video communications, chat communications, etc. whereas the non-real-time communication channels may include email communications. If a request to access the account is provided, the functionalities and mechanisms of the online service server 135 may also be embodied for security access data that may be used in this access attempt performed in a non-network manner. Furthermore, as will become evident below, a combination of network and non-network embodiments may also be provided through the functionalities and mechanisms according to the exemplary embodiments.

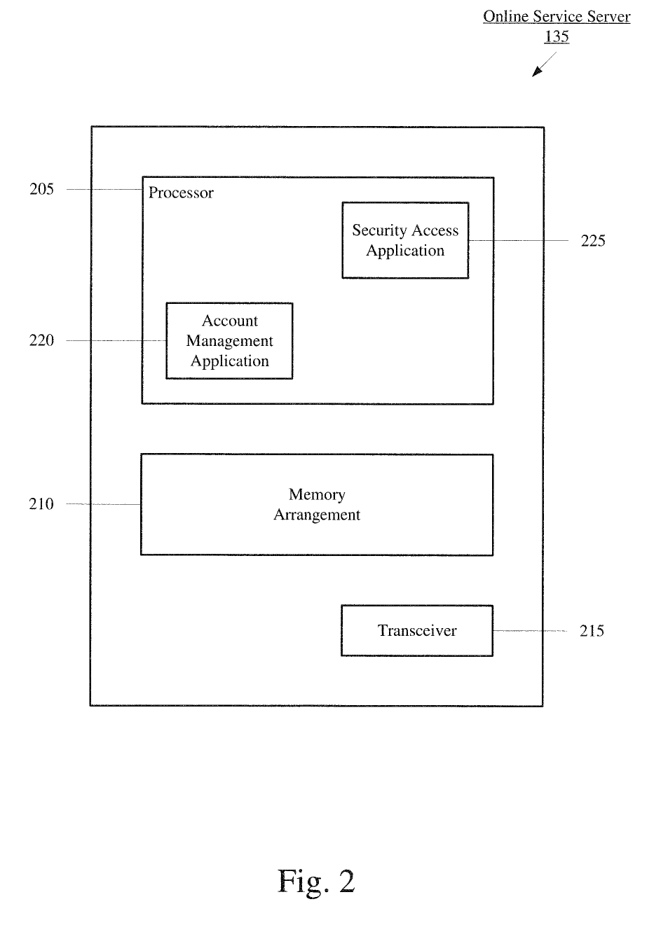

FIG. 2 shows an exemplary embodiment of the online service server 135 of the system 100 of FIG. 1 according to the present disclosure. The online service server 135 may represent any electronic device that is configured to perform the functionalities and mechanisms described herein. As shown in

FIG. 2, the online service server 135 may include a processor 205, a memory arrangement 210, and a transceiver 215. The processor 205 may execute a plurality of applications, the memory arrangement 210 may store data related to the applications (e.g., performing the functionality of a read access memory (RAM)), and the transceiver 215 may establish a connection to the Internet and the communications network 110. It should be noted that the online service server 135 may also include further components (e.g., a display device and an I/O device) that enable an administrator to configure the online service server 135 to perform its desired functionalities and mechanisms. However, it should also be noted that the online service server 135 may be configured to receive these instructions via the transceiver 215 to automatically implement the policies upon reception.

The processor 205 may be configured to execute a plurality of applications including an account management application 220. The account management application 220 may provide a plurality of functionalities. In a first exemplary functionality, the account management application 220 may perform operations associated with creating an online account for the user. As discussed above, the user utilizing the user device 105 may wish to create an online account with the website hosted by the online service server 135. Accordingly, the website may include an option for the user to create the online account. When the option is selected, the account management application 220 may provide requests associated with the creation of the online account. For example, the account management application 220 may request general information such as the user's real name, address, email address, age, a login name, a login password, etc. After the general information has been provided, the account management application 220 may request the security access data such as one or more security question/answer combinations. The account management application 220 may receive the security question/answer combinations for further processing as will be described in further detail below. When the security question/answer combinations have been approved, the account management application 220 may complete the creation of the online account. Thus, the general information and the security access data may be stored in the data repository 140 for the user. The account management application 220 may create the account such as creating a user account profile in which the information received during the account creation process is associated. Accordingly, the user may access the online account using the login/password.

In a second exemplary functionality, the account management application 220 may perform operations associated with maintaining the online account. Once the online account has been created, the account management application 220 may perform a variety of different operations to manage and maintain the online account until the online account is terminated. For example, the account management application 220 may continue to store the general information and the security access data in the data repository 140. The account management application 220 may request the user to provide any updates to the general information. In another example according to the exemplary embodiments, the account management application 220 may perform a validation process. The validation process may be used to validate strength values of the security question/answer combinations as will be described in further detail below. The strength values may relate to how easy or frequent (i.e., available) that information pertaining to the security question and/or the answer thereto is discoverable or found from the third party sources (e.g., Internet searches). That is, the strength value may represent an availability value of responses to the security question. Therefore, the validation process may relate to how the strength values may change from a time the online account was created to a current time when the strength values are validated. If the strength value of a first security question/answer combination falls below a predetermined threshold, the account management application 220 may request that a second security question/answer combination be provided to replace the first security question/answer combination. When the strength values of the security question/answer combinations have been validated and are all above the predetermined threshold, the account management application 220 may complete the validation process.

It should be noted that the validation process may be performed at a variety of different times. In a first example, the account management application 220 may perform the validation process at predetermined times (e.g., once every 12 hours, once a day, once a week, once a month, etc.). In a second example, the account management application 220 may perform the validation process dynamically such as when a change to a strength value is determined to have a high likelihood. In a third example, the account management application 220 may perform the validation process using a combination of the above described times.

In a third exemplary functionality, the account management application 220 may perform operations associated with responding to an account access request. After the online account has been created, the user may request to access the online account. However, in a first example, the user may have forgotten the login and/or password to access the online account and is requesting the forgotten component to be provided. In a second example, the website may utilize increased security measures such that a security question/answer combination is used for the account access request. Accordingly, the account management application 220 may transmit a security question and request the stored answer associated therewith be provided. If an incorrect security question/answer combination is provided, a subsequent security question may be transmitted to request the stored answer associated therewith to be provided. When the security question/answer combination is finally provided, the account management application 220 may respond to the account access request. In the first example, the forgotten component may be transmitted via the provided email stored in the general information. In the second example, the online account may be accessed. According to the exemplary embodiments and as will be described in further detail below, the strength values associated with the security question/answer combination may affect the manner in which the account access request operations are performed by the account management application 220.

It should be noted that the above functionalities performed by the account management application 220 are only exemplary. Those skilled in the art will understand that the account management application 220 may perform further functionalities associated with creating and managing online accounts for the website hosted by the online service server 135.

The processor 205 may also be configured to execute a security access application 225. The security access application 225 may provide the operations utilized associated with determining the strength values of the security access data. As described above, during the creation of the online account, the account management application 220 may request security access data such as security question/answer combinations to be provided. When received, the security question/answer combinations may be further processed where the security access application 225 determines a strength value for each of the security question/answer combinations.

For each security question that is selected by the user for use in the security access data, the security access application 225 computes a strength value. The security access application 225 may also compute a strength value based upon a provided answer to the selected security question (i.e., a security question/answer combination). The strength value may be provided to the account management application 220 to be used accordingly.

In a first example, during the creation of the online account, the strength value may be used to determine whether the security question is to be included or excluded from a list of available security questions. Specifically, the account management application 220 may include a list of security questions that may be used by the user for the security access data. A strength value for each of the security questions may be determined and provided by the security access application 225 to the account management application 220. The account management application 220 may perform subsequent actions based upon these strength values. In a first example, the account management application 220 may eliminate security questions having a strength value that is lower than a predetermined threshold value. Thus, the list of security questions may be limited to create the list of available (or remaining) security questions. The account management application 220 may determine if there is a sufficient number of available security questions and may select further security questions (whose strength value satisfies the predetermined threshold value) to be included in the list of available security questions. In a second example, the account management application 220 may provide a visual representation of the strength value associated with a security question. The strength value may be shown to the user in a substantially similar manner as that used in conventional systems to provide a strength indicator for passwords (e.g., a weak password including only an alphanumeric combination may be shown with a red indicator, a medium strength password further including at least one capital letter may be shown with a yellow indicator, and a strong password additionally including at least one symbol may be shown with a green indicator). In this manner, the strength value determined by the security access application 225 may be used during the creation of the online account with regard to the security access data.

In a second example, the strength values may be verified. As described above, as time passes, the strength value of the security access data (e.g., security question/answer combination) may change. Specifically, the security access data may be weaker in strength. When the account management application 220 determines that the validation process is to be performed, the security access application 225 may determine the strength value of the security access data. When the strength value of the security access data determined by the security access application 225 is provided, the account management application 220 may perform further operations. For example, if the security access data has a strength value that falls under a predetermined threshold value, the user may be notified of this change. The user may be requested or forced to change the security access data (e.g., replace the security question for a different security question having a strength value over the predetermined threshold value). In another example, if the security access data had an original strength value that falls to a current strength value whose difference is greater than a predetermined threshold value, the user may be notified of this change. The user may be requested or forced to change the security access data.

In a third example, the strength value may be used during the above described third functionality of the account management application 220 during a response to an account access request. While security question/answer combinations are used for validating a user (e.g., during a login procedure, during login and/or password retrieval, etc.), the strength value may affect the manner in which the security access data is used in this validation process. For example, the account management application 220 may provide security questions and receive answers to determine whether the stored security question/answer combination has been provided. For each correct combination that is provided, the strength value may be added. The account management application 220 may validate the user only when the added strength values have surpassed a predetermined threshold value. In another example, the account management application 220 may provide a security question for the user to provide an answer. The account management application 220 may also apply a timer in which the user is allowed to correctly answer the security question. Based upon the strength value of the security question/answer combination, the account management application 220 may adjust the timer. Specifically, a first security question/answer combination may have a first strength value and a second security question/answer combination may have a second strength value lower than the first strength value. If the account management application 220 were to select the second security question, the timer associated therewith may be shorter than the timer if the first security question were to be selected. In a further example, a combination of the above described features may be used in the validation process.

The above describes various mechanisms in which the strength value determined by the security access application 225 may be used. The security access application 225 may determine the strength value using a variety of different manners. In a first manner, the security access application 225 may perform a public online search. The public online search may include general searches for information of the user as may be used in the security access data or pertain thereto (e.g., answer to a security question). For example, if a security question relates to a town in which the user grew up, the public online search may perform a public search of local newspapers that may have had an article of the user during the time period associated with the security question. The local newspaper may have a website that may be hosted, for example, by the server 115 which is accessible in a public way (i.e., viewable by any visitor to the website). The public online search may also utilize general search engines (e.g., Google, Yahoo, etc.). In another example, the security access application 225 may refine the public online search. As described above, the servers 115, 125 may host social network websites (e.g., Facebook, Twitter, LinkedIn, etc.). Those skilled in the art will understand that the user may enable select items to be viewed publicly by any visitor to the social network website of the user. The public online search may accordingly include the publicly available items on the social network websites of the user. The public online search may also include the publicly available items on the social network websites of people linked to the user (e.g., within the social network of the user). The public online search may further include further types of websites that may be hosted by the servers 115, 125. For example, the further types of websites may include online diary websites such as blogs or vlogs (e.g., YouTube), review websites (e.g., Yelp, TripAdvisor, etc.), and other online venues for the user to post content on the Internet. The above noted aspect of the publicly available content for these further types of websites may also apply.

Accordingly, the security access application 225 may perform a public online search in this manner to determine any keywords or results that pertain to the selected security question.

In a second manner, the online account may include a profile or an indication that enables the online service server 135 to perform a private online search. The private online search may include a further refined search. Specifically, the private online search may relate to the social network websites as well as the further types of websites in which the user may have an online account. As noted above, the online account with these websites may have select content that is publicly available and remaining content that is privately available (e.g., to only other users who are in the social network of the user). The private online search may be performed on the remaining content that is privately available. The private online search may also extend to other users in the social network of the user. For example, if the online service server 135 has access to the online account of a social network website, the access may also extend to the others users within the social network of the user. To enable the private online search for the security access application 225 to perform, the user may provide access to these other online accounts.

The access utilized by the security access application 225 to perform the private online search may be provided in a variety of manners. In a first example, the user may provide a token to the online service server 135 that enables the private online search to be performed. The token may have an expiry such that the access to the other online account is on a temporary basis. The token may also be individualized to each other online account. Thus, if the user has three other online accounts in which the private online search may be performed, a respective token may be required to be provided. In this manner, the user may control which of the other online accounts are to be considered in the private online search. In a second example, the user may indicate that the access is allowed such that the online service server 135 may contact the servers 115, 125 with the access grant to perform the private online search. In a third example, the user may manually add the online service server 135 into the social network or authorized user to view the private content. The security access application 225 may then perform the private online search. However, the user may also be responsible for removing the online service server 135 at a subsequent time if the access is to remain temporary. However, the user may also select to provide permanent access to the other online accounts such that the private online search may be performed at any time while the online account with the online service server 135 is alive.

The account management application 220 may provide an option for the user to select that enables the private online search. For example, during the creation of the online account, the account management application 220 may request that the private online search be enabled by providing the access grant to select or all other online accounts in which there is private content. Thus, the user may provide the access grant and a list of other online accounts. The account management application 220 may receive the access grant and provide the access grant to the security access application 225 for the private online search to be performed. The access may be temporary or permanent. When permanent, any subsequent private online search may be performed without any user intervention. However, when temporary, the account management application 220 may request the access grant whenever the private online search will be performed. In another example, during a subsequent opportunity for the private online search to be performed after the online account has been created and no permanent access grant existing, the account management application 220 may transmit a request to a known contact mechanism (e.g., email) for the access grant to be provided for the private online search to be performed.

Through granting permission for the private online search to be performed, the security access data may be more thoroughly verified with regard to strength value. Although the public online search may be pertinent as to whether information pertaining to the security question is publicly available, the private online search may provide further information pertaining to the security question that is privately available. This process thereby increases the confidence of the strength value of the security access data. Accordingly, the security access application 225 may perform a private online search in this manner to determine any keywords or results that pertain to the selected security question.

With the public online search and/or the private online search available to the security access application 225, the results of the searches may be used as the basis to determine the strength value of the security access data. The strength value may be calculated within a range of possible values or as a binary value. For example, as a range, the strength value may be calculated on a 0 to 10 scale, a 0 to 100 scale, a weak to strong scale, a color scale, etc. In another example, as a binary value, the strength value may be calculated as safe/unsafe, strong/weak, etc. To qualify as a value within the range scale or as one of the binary values, predetermined threshold ranges may be utilized based upon the search results. Specifically, an ease or frequency in which the security access data is identified from the searches may identify the strength value. In a simplest case with the binary value, a security question whose answer is empty or not found in the searches may result in a safe strength value, otherwise unsafe. A more complicated mapping from search responses to the strength value may take into consideration the strength of the match between the security question and the search results and an estimate of the effort it would take to convert the search results into the answer to the security question.

As noted above, the security access data may relate to security questions and how the search results for the security question may be ascertained from the searches. It was also noted that the answer that is provided for the security question may also be incorporated into the strength value analysis. That is, the security question/answer combination may be used as the basis to determine the strength value. For example, if the provided answer is easily found from the searches, the strength value may be relatively low. Accordingly, a further analysis may be performed for the combination beyond the analysis performed for only the security question.

It should be noted that there may be further considerations particularly when the combination is considered in the strength value analysis. Specifically, the user may manually increase security by knowingly providing an intentionally incorrect answer to a security question. For example, the security question may ask the year the user graduated from high school. Although the user may posted content that the user graduated from high school in 2005, the user may select to provide an answer indicating 2001. The security access application 225 may still perform the searches and analyze the search results to provide to the account management application 220. The account management application 220 may be configured to warn the user about various answers determined from the searches for the security question for the user to take into account if the user would remember the intentionally different answer.

It should be noted that the above noted applications each being an application (e.g., a program) executed by the processor 205 is only exemplary. The functionality associated with the applications may also be represented as components of one or more multifunctional programs, a separate incorporated component of the online service server 135 or may be a modular component coupled to the online service server 135, e.g., an integrated circuit with or without firmware.

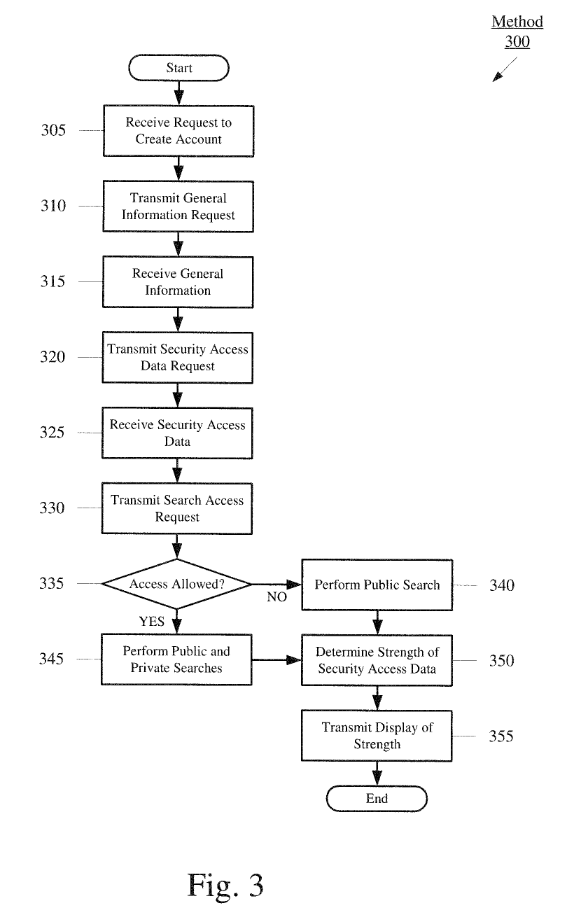

FIG. 3 shows an exemplary embodiment of a method 300 for validating a strength value of security access data during a creation of an online according to the present disclosure.

Specifically, the method 300 may relate to the online service server 135 determining a strength value associated with a security question (or security question/answer combination) provided by the user and evaluate whether the security question provides at least a predetermined level of security for the online account. The method 300 will be described with regard to the system 100 of FIG. 1 and the online service server 135 of FIG. 2.

In step 305, the online service server 135 receives a request from the user device 105 to create an online account for the user. As discussed above, the user of the user device 105 may have a plurality of online accounts such as with a first website hosted by the server 115 and a second website hosted by the server 125. The user of the user device 105 may also wish to create another online account such as with a third website hosted by the online service server 135. The third website hosted by the online service server 135 may have a web page with an option (e.g., selectable icon) to initiate the online account creation process. Specifically, the account management application 220 may be used to complete the online account creation.

In step 310, the online service server 135 transmits a request for general information. For example, when the option of a selectable icon is used on the third website, the icon may link to a further web page with a form in which the general information may be entered by the user of the user device 105. The general information may include any type of information that is requested including the user's real name, date of birth, contact email, contact telephone number, etc. In step 315, the online service server 135 receives the general information via the user device 105. The online service server 135 may store the general information in the data repository 140 for the online account that is being created for the user.

In step 320, the online service server 135 transmits a request for security access data. For example, when the general information web page has been completed and a further selectable icon (e.g., proceed to next step icon) is used on the third website, the further icon may link to a yet further web page with a further form in which the security access data may be entered by the user of the user device 105. The security access data may relate to a set of predetermined security questions in a list selectable by the user. When a security question has been selected, an answer thereto may be provided. The security access data may include a predetermined number of security questions and answers thereto (e.g., security question/answer combination). In step 325, the online service server 135 receives the security access data that has been provided from the user device 105. The online service server 135 may store the security access data in the data repository 140 for the online account that is being created for the user.

In step 330, the online service server 135 transmits a request to access private content to perform a search related to the security access data. The online service server 135 may generate a request for the user to provide an access grant (e.g., a token) and one or more other online accounts (e.g., associated with the websites of the servers 115, 125) for a private online search to be performed.

In step 335, the online service server 135 either receives the access grant or does not receive the access grant.

If no access grant is provided, the online service server 135 continues the method 300 to step 340 in which the security access application 220 performs only a public online search. As described above, the public online search may be for public content that may be viewed by any visitor of a web page such as a web page of a social networking website in which the user has an online account. If an access grant is provided, the online service server 135 continues the method 300 to step 345 in which the security access application 220 performs a public online search and a private online search using the access grant. As described above, the private online search may be for private content that may only be viewed by authorized users such as a private content on a web page of a social networking website having a “friends only” permission.

After the public search and/or private search has been performed, in step 350, the online service server 135 determines a strength value of the security access data. For example, for a particular security question (or security question/answer combination), the search results may indicate a strength value as would be relative to a security for the online account. The strength value may relate to an ease/difficulty and availability/unavailability for the answer to the security question may be ascertained from sources on or from the Internet. In step 355, the strength value associated with the security access data may be transmitted to the user device 105 for viewing by the user. Accordingly, the user may determine whether the use of a particular security question is warranted for use in the security access data or if a different security question should be selected to improve the security of the online account.

It should be noted that the method 300 may include further steps and features. For example, the security access data may allow for further security questions to be included in the security access data. Thus, the method 300 may include further iterations of transmitting a request for security access data until a quota of security questions has been satisfied. In another example, as described above, the list of predetermined security questions may be refined based upon the searches that are performed. That is, the steps of the method 300 may be utilized in a different order for a different feature to be provided. In this manner, security questions in the list may be removed from being selected by the user if the search results indicate that the use of a particular security question has a high probability of providing a low security (i.e., a low strength value).

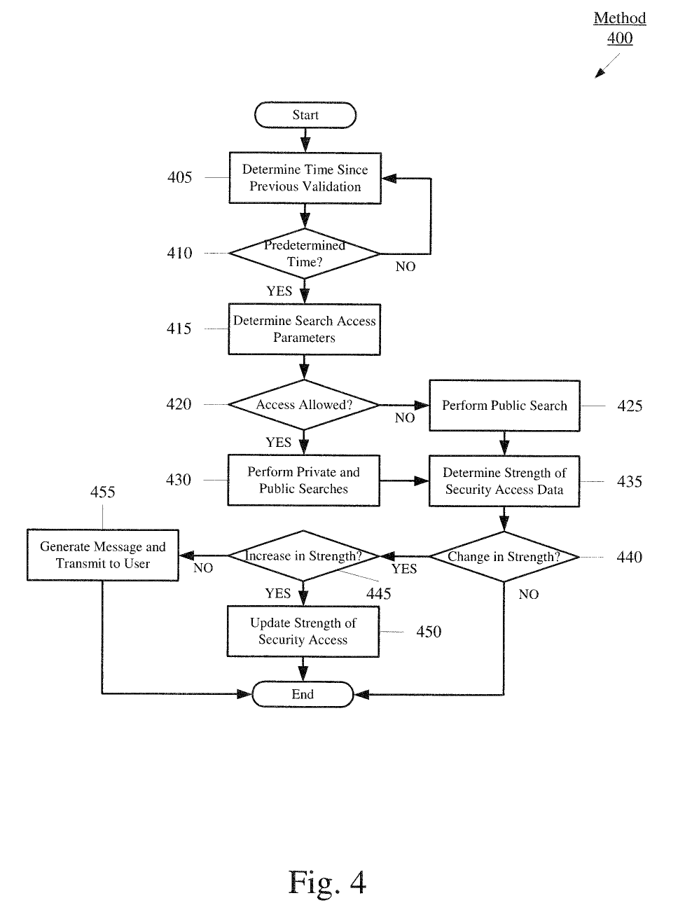

FIG. 4 shows an exemplary method 400 for validating a strength value of security access data after an online account has been created according to the present disclosure. Specifically, the method 400 may relate to the online service server 135 determining a subsequent strength value associated with a security question (or security question/answer combination) provided by the user and evaluate whether the security question still provides at least a predetermined level of security for the online account. The method 400 will be described with regard to the system 100 of FIG. 1 and the online service server 135 of FIG. 2.

In step 405, the online service server 135 determines a time period since a validation process was performed. Specifically, the online service server 135 determines when the immediately previous validation process was performed. It may be assumed that the online service server 135 has been performing the functionalities described herein for a period of time and is not a first iteration of the functionalities being performed. Accordingly, the online service server 135 may determine this time frame that has elapsed from the previous validation process that was performed.

In step 410, the online service server 135 determines whether a predetermined time has been reached. As described above, the predetermined time may be set in a variety of manners. In a first example, the predetermined time may be at selected intervals of time. Specifically, the online service server 135 may perform the validation process of the method 400 at every selected time interval (e.g., every hour, every 6 hours, every day, every 2 days, etc.). It is noted that the time interval may be used in a constant manner (e.g., always performed every day) or may be used in an mixed manner (e.g., performed every day for a first week and performed every other day for a second week). In a second example, the predetermined time may be when an event is triggered. Specifically, the online service server 135 may perform the validation process of the method 400 when a likelihood of a change to a strength value over a predetermined amount is detected. Another example of an event may be when a breach of another site has occurred. If the predetermined time has not been reached, the online service server 135 returns the method 400 to step 405. However, if the predetermined time has been reached, the online service server 135 continues the method 400 to step 415.

In step 415, the online service server 135 determines the search access parameters associated with the online account of the user. It is noted that the online service server 135 may perform the validation process for online accounts on an individual basis or as an overall basis. That is, the online service server 135 may perform the validation process for each online account at the predetermined time or may perform the validation process for an individual online account when the predetermined time for the individual online account has been reached. Accordingly, the online accounts being tracked by the online service server 135 may have a common time value used to determine the predetermined time or may have a respective time value.

The search access parameters for the online account may relate to whether the online service server 135 has an access grant to perform a private online search in addition to a public online search. As discussed above, the private online search may require the access grant as only authorized users may have permission to view private content of the user. If the online service server 135 is provided a permanent access grant, the search access parameters may indicate this permanent access grant to understand that the private online search may be performed at any time. However, the access grant may be provided on a temporary basis. Thus, if a temporary access grant is provided during the creation of the online account or at a previous validation process, there may no longer be an access grant to perform a private online search for the current validation process. Accordingly, the online service server 135 may transmit a request for the access grant to be provided by the user.

In step 420, the online service server 135 determines whether the access grant has been provided. If no access grant is provided, the online service server 135 continues the method 400 to step 425 in which the security access application 220 performs only a public online search. If an access grant is provided, the online service server 135 continues the method 400 to step 430 in which the security access application 220 performs a public online search, a private online search, or a combination thereof using the access grant. After the public search and/or private search has been performed, in step 435, the online service server 135 determines a strength of the security access data.

In step 440, the online service server 135 determines whether there is a change in the strength value. Specifically, with the security access data including one or more security questions (or security question/answer combinations), the online service server 135 may determine whether any of the security questions has had a change in the strength value. For example, a security question may ask for the name of a favorite pet. During a previous validation process (e.g., during the creation of the online account), a private online search and a public online search may have no results for an answer to this security question. However, since then, the user may have created a blog for an online diary for a pet whose name is referenced often. Accordingly, the strength value for this security question may have decreased significantly. In contrast, the private online search and the public online search may have had a few results for an answer to the security question. However, since then, the user may have removed any instances of content that refers to the answer to the security question. Accordingly, the strength value for this security question may have increased. In a further example, if the user has not changed any content since the previous validation process, the strength value may remain the same since the previous validation process. If no change in the strength value is determined, the method 400 may end and the strength value for the security access data may remain the same.

However, if there is a change in the strength value of the security access data (e.g., for at least one security question), the online service server 135 continues the method 400 to step 445. In step 445, the online service server 135 determines whether the strength value has changed. As noted above, the change in the strength value may increase or decrease from a previous validation process. If the strength value has increased, the online service server 135 continues the method 400 to step 450 where the online service server 135 may update the strength value for the security access data as stored in the data repository 140.

If the strength value has decreased, the online service server 135 continues the method 400 to step 455. In step 455, the online service server 135 may generate a message and transmit the message indicating the decrease in strength value to the user. The message may be transmitted to, for example, a contact address (e.g., email, text, etc.) provided by the user (as stored in the general information of the online account). The message may indicate that the user should access the online account and update the security access data since the decrease in strength value may no longer provide sufficient security for the online account.

It should be noted that the above mechanism for the decrease in strength value is only exemplary and that the online service server 135 may utilize other mechanisms upon detecting this event. In another example, the online service server 135 may determine the degree in which the strength value has decreased. If the strength value has decreased below a predetermined threshold value, the online service server 135 may determine that the security access data is no longer valid to be used. Accordingly, the online service server 135 may require that the user update the security access data such as selecting a different security question that increases the strength value of the security access data above the predetermined threshold value. In a further example, the online service server 135 may determine the change in the strength value. If the change in the strength value has decreased below a predetermined threshold value, the online service server 135 may determine that the security access data may warrant review by the user (e.g., the answer to the security question may be determined more easily from a previous validation process). Accordingly, online service server 135 may require that the user accept the responsibility of the new strength value for the security access data.

It should be further noted that the method 400 may include further steps and features. For example, the user may have provided an access grant during a previous validation process but may deny a further access grant for a current validation process. Accordingly, the strength value may not reflect the same search results that are found from performing a public online search as well as a private online search.

Specifically, the strength value of the security access data may decrease significantly due to the lack of a private online search from being performed. In another example, the user may have denied the access grant during a previous validation process but may provide an access grant during a current validation process. Accordingly, the strength value may again not reflect the same search results. Specifically, the strength value of the security access data may be further refined from performing the private online search. Therefore, the online service server 135 may perform additional steps to perform the proper set of operations in determining whether the change (particularly a decrease) in strength value warrants further action.

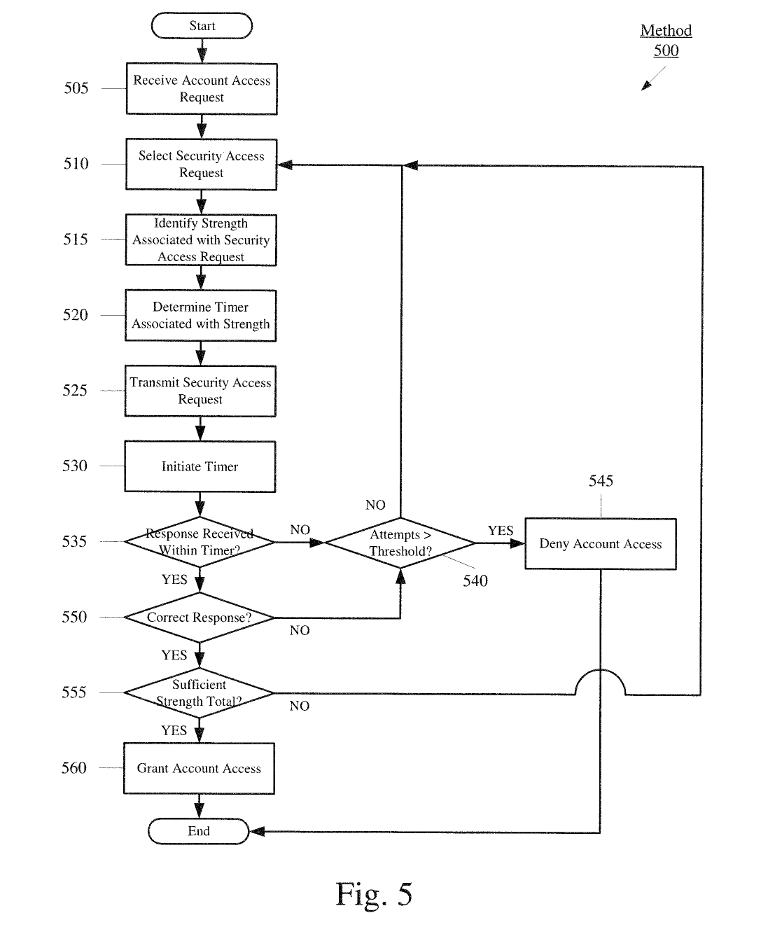

FIG. 5 shows an exemplary method 500 for responding to an account access request according to the present disclosure. Specifically, the method 500 may relate to the online service server 135 utilizing the strength value associated with a security question (or security question/answer combination) to perform a user validation process. The method 500 will be described with regard to the system 100 of FIG. 1 and the online service server 135 of FIG. 2.

In step 505, the online service server 135 receives a request to access an online account. As described above, the request to access the online account may be related to a variety of different scenarios. In a first example, the request to access the online account may be when the user is requesting to log into the online account (e.g., entering a user login and password). In a second example, the request to access the online account may be when the user has forgotten a credential to log into the online account (e.g., requesting the user login and/or password used to log into the online account). Accordingly, the request to access the online account may relate to a user validation process (in contrast to the validation process described above which relates to the strength value of the security access data).

In step 510, the online service server 135 selects the security access data to be used in the user validation process. For example, when the security access data includes one or more security question/answer combinations (as stored in the data repository 140 for the user account), the online service server 135 may select a first security question from the security access data. In step 515, the online service server 135 may identify the strength value associated with the selected security question (which may also be stored in the data repository 140). As noted above, the strength value may be determined based upon a variety of different manners such as within a range of values, a binary value, etc. In step 520, the online service server 135 determines a timer to be used based upon the strength value associated with the first security question. For example, the strength values may be within a range (e.g., 0-10 scale). A security question having a high strength value (e.g., 10) may have a timer value that is high (e.g., 30 seconds). A security question having a low strength value (e.g., 2) may have a timer value that is low (e.g., 10 seconds).

In step 525, the online service server 135 transmits the first security question to the user device 105 to allow the user to provide the answer thereto. For example, the process of requesting the access to the online account may utilize a particular web page on the website hosted by the online service server 135. When the user validation process is utilized, the web page may forward the user to another web page or a window in which the first security question is displayed and posed to the user of the user device 105. When the first security question has been transmitted, in step 530, the online service server 135 initiates a timer whose duration is based upon the determined timer from the operation above.

In step 535, the online service server 135 determines whether a response to the first security question has been received within the duration of the timer. If no response is received and the timer has expired, the online service server 135 continues the method 500 to step 540. The online service server 135 may utilize an attempt threshold in which a predetermined number of incorrect attempts at providing the correct answer to security questions results in a denial of access to the online account. For example, the user may have provided an incorrect answer to one or more security questions. The user may have also provided no answer to one or more security questions. The attempt threshold may be that three incorrect attempts results in a denial of access to the online account. Thus, in step 540, if a response is not received within the duration of the timer or is incorrect, the online service server 135 may determine whether the number of attempts at providing a correct answer is greater than a predetermined attempt threshold. If the number of attempts has not been passed, the online service server 135 returns the method 500 to step 510 in which a different security question is selected for use in the user validation process. As the current user validation process is still on the first security question and the attempt threshold may be greater than one, the online service server 135 may perform this operation. However, if the number of attempts is greater than the attempt threshold (e.g., the attempt threshold is rigid and set to 0 or 1), the online service server 135 continues the method 500 to step 545. In step 545, the online service server 135 denies the access to the online account. It should be noted that the denial of the access to the online account may include further features. For example, the online account may be prevented from being accessed for a set period of time. In another example, the online account may be prevented from being accessed until the user contacts a contact center that manages the online account.

Returning to step 535, if the user has provided a response within the duration of the timer, the online service server 135 continues the method 500 to step 550. In step 550, the online service server 135 determines whether the response is the answer to the first security question. As noted above, the user may not provide a response within the timer or provide an incorrect response to the first security question. If the response is not the answer to the first security question, the online service server 135 continues the method 500 to step 540.

The remaining option at step 550 is that the user has provided the answer to the first security question within the duration of the timer. When this occurs, in step 555, the online service server 135 determines whether a sufficient strength total has been reached for the user validation process.

As described above, the strength values may further be utilized to amass a strength total that must be satisfied for the user validation process to be passed. Thus, the strength value that was previously identified may be added to the strength total. As this process is currently at the first security question, the strength total may be the identified strength value. Further iterations of the method 500 may result in the strength total to increase (if necessary). It is noted that the strength total may be set such that at least two security questions must be posed to the user. For example, with a strength value scale from 0-10, the strength total may be greater than 10 such that a correct answer to a security question have the highest strength value is still insufficient to pass the user validation process. However, this is only exemplary and the strength total may not have such a requirement. Furthermore, the strength total may also be flexible. For example, the strength total may have a condition in which a security question have the highest strength value is correctly answered, this may automatically be sufficient to satisfy the strength total requirement. Thus, if the strength total has not yet been satisfied, the online service server 135 returns the method 500 to step 510 for a further security question to be posed to the user. However, if the strength total has been satisfied, the online service server 135 continues the method 500 to step 560. In step 560, the online service server 135 grants access to the online account.

For example, the user maybe logged into the online account. In another example, the user may be transmitted a message (e.g., via email) of the user login or password to be used in logging into the online account.

It should be noted that the method 500 may include further steps and features. For example, the use of the timer may also be associated with a number of attempts allowed to respond to the first security question. In contrast to a total number of attempts to answer a set of security questions, this may relate to a number of attempts at successfully answering a particular security question. That is, a preselected number of attempts may only be used to provide the correct answer to a selected security question. Thus, the online service server 135 may incorporate such a feature such that the user is allowed to attempt to answer the security question more than once. For example, a given security question may allow the user to provide the correct answer within three attempts. It is noted that the strength value may also be used as a means to determine the number of allowed attempts to answer a security question. For example, a security question having a high strength value may provide the user with an additional number of attempts to provide the correct answer. However, a security question having a low strength value may provide the user with a fewer number of attempts to provide the correct answer. If the security question has the lowest strength value, the user may be provided only a single opportunity to provide the correct answer.

The exemplary embodiments provide a device, system, and method of validating a strength value of security access data associated with an online account. The strength value may be used to determine a relative security of the online account such as providing a minimum security level for the user of the online account. The strength value may be determined using a variety of different searches including a public online search, a private online search, or a combination thereof. The strength value may also be used in a variety of different manners such as during a user validation process.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation. Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
receiving, by an online service server, a security question data from a user device, the security question data being utilized for a user authentication to access an account of a user;
performing, by the online service server, a search, using third party sources, to generate search result data, the search result data being indicative of an availability value of responses to the security question data; and
determining, by the online service server, a strength value of the security question data based on the search result data.

2. The method of claim 1, further comprising:
receiving, by the online service server, an answer data from the user device, the answer data corresponding to the security question data and being utilized for the use authentication;
performing, by the online service server, a further search, using the third party sources, to generate further search result data, the further result data being indicative of a further availability value of further responses to the security question data with the answer data; and
determining, by the online service server, a further strength value of the security question data with the answer data based on the further search result data.

3. The method of claim 1, wherein the security question data is selected by the user from a plurality of predetermined security question data.

4. The method of claim 1, further comprising:
receiving, by the online service server, an access grant from the user; and
accessing, by the online service server, the third party sources using the access grant.

5. The method of claim 1, further comprising:
transmitting, by the online service server, an indicator to the user device representing the strength value of the security question data.

6. The method of claim 2, further comprising:
transmitting, by the online service server, an indicator to the user device representing the further strength value of the security question data with the answer data.

7. The method of claim 1, further comprising:
comparing, by the online service server, the strength value of the security question data to a predetermined threshold value of a minimum security level;
when the strength value is greater than the predetermined threshold value, associating, by the online service server, the security question data with the account; and
when the strength value is lower than the predetermined threshold value, requesting, by the online service server, an update to the security question data from the user.

8. The method of claim 1, wherein the performing is performed at a subsequent time, the subsequent time being one of at a predetermined time interval, at a dynamic time interval, and upon detecting an event, and wherein the determining is performed at the subsequent time to determine a subsequent strength value.

9. The method of claim 8, further comprising:
comparing, by the online service server, the subsequent strength value to a predetermined threshold value of a minimum security level; and
when the subsequent strength value is lower than the predetermined threshold value, requesting, by the online service server, an update to the security question data.

10. The method of claim 8, further comprising:
comparing, by the online service server, the subsequent strength value to the strength value; and
when the subsequent strength value has decreased from the strength value by a predetermined difference value, requesting, by the online service server, an update to the security question data.

11. An online service server, comprising:
a transceiver communicating with a communications network to communicate with a user device utilized by a user, the transceiver receiving a security question data from the user device, the security question data being utilized for a user authentication to access an account of a user;
a processor coupled to the transceiver; and
a memory arrangement with an executable program stored thereon, the program instructing the processor to perform operations comprising:
performing a search, using third party sources, to generate search result data, the search result data being indicative of an availability value of responses to the security question data; and
determining a strength value of the security question data based on the search result data.

12. The online service server of claim 13, wherein the transceiver further:
receives an answer data from the user device, the answer data corresponding to the security question data and being utilized for the user authentication, and
wherein the program instructing the processor to perform operations further comprising:
performing a further search, using the third party sources, to generate further search result data, the further result data being indicative of a further availability value of further responses to the security question data with the answer data; and
determining a further strength value of the security question data with the answer data based on the further search result data.

13. The online service server of claim 11, wherein the transceiver further transmits a plurality of predetermined security question data and receives a selection from the user device of the security question data.

14. The online service server of claim 11, wherein the transceiver further receives an access grant from the user, the access grant being used to access the third party sources.

15. The online service server of claim 11, wherein the transceiver further transmits an indicator to the user device representing the strength value of the security question data.

16. The online service server of claim 11, wherein the program instructing the processor to perform operations further comprising:
comparing the strength value of the security question data to a predetermined threshold value of a minimum security level;
when the strength value is greater than the predetermined threshold value, associating the security question data with the account; and
when the strength value is lower than the predetermined threshold value, requesting an update to the security question data from the user.

17. The online service server of claim 11, wherein processor performs the search at a subsequent time.

18. The online service server of claim 17, wherein the subsequent time is one of at a predetermined time interval, at a dynamic time interval, and upon detecting an event.

19. The online service server of claim 11, wherein the online service server is associated with a contact center that manages the account.

20. A method, comprising:
receiving, by an online service server, an access request to access an account of a user from a user device, the account associated with a user account profile data including a security question data, an answer data corresponding to the security question data, and a strength value corresponding to the security question data, the strength value based on search result data of a search using third party sources, the strength value being indicative of an availability value of responses to the security question data;
determining, by the online service server, a timer value based on the strength value;
transmitting, by the online service server, an answer request to the user device requesting the answer data to be provided for the security question data; and
granting, by the online service server, access to the account by the user device when the answer data is received within the timer value.
